(19) United States
(12) Patent Application Publication
(10) Pub. No.: US 2013/0246543 A1
(43) Pub. Date: Sep. 19, 2013

(54) NETWORKED SENSOR DEVICE

(71) Applicant: AMPERIC INC., Brookline, MA (US)

(72) Inventor: Richard Edward Pasek, Brookline, MA (US)

(73) Assignee: AMPERIC INC., Brookline, MA (US)

(21) Appl. No.: 13/838,776

(22) Filed: Mar. 15, 2013

Related U.S. Application Data
(60) Provisional application No. 61/612,609, filed on Mar. 19, 2012.

(51) Int. Cl. H04L 12/58

(52) U.S. Cl. CPC H04L 51/04
USPC 709/206

(57) ABSTRACT

Disclosed are various embodiments for networked sensor devices. In one embodiment, a networked sensor device is configured to obtain sensor readings from one or more sensors and then store the sensor readings in an email server by way of a wireless or wired network. In one embodiment, a client is configured to obtain one or more reporting emails generated by a networked sensor device, extract data from the reporting email(s), and render a user interface that presents the data extracted from the reporting email(s), where the data includes sensor readings generated by the networked sensor device.

### CROSS-REFERENCE TO RELATED APPLICATION(S)

This application claims priority to co-pending U.S. Provisional Application Ser. No. 61/612,609, filed Mar. 19, 2012, which is hereby incorporated by reference herein in its entirety.

### BACKGROUND

Digital sensors have increasingly replaced conventional analog sensors for temperature, humidity, motion, and other detected readings. Such digital sensors may integrate into home automation systems using protocols such as X10, Z-Wave, and so on.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIGS. 2-13 depict examples of user interfaces rendered by a browser executing a configuration application in a client to configure a networked sensor device in the networked environment of FIG. 1 according to various embodiments of the present disclosure.

FIGS. 14A-16 depict examples of user interfaces rendered by an email client application executed in a client in the networked environment of FIG. 1 according to various embodiments of the present disclosure.

FIGS. 17A-20 illustrate examples of user interfaces generated by a sensor device client application executed in a client in the networked environment of FIG. 1 according to various embodiments of the present disclosure.

FIG. 21 is a flowchart illustrating one example of functionality implemented as portions of control logic executed in a networked sensor device in the networked environment of FIG. 1 according to various embodiments of the present disclosure.

FIG. 22 is a schematic block diagram that provides one example illustration of a networked sensor device employed in the networked environment of FIG. 1 according to various embodiments of the present disclosure.

FIGS. 23A-23F are circuit diagrams illustrating principles of battery protection logic employed in the networked sensor device in the networked environment of FIG. 1 according to various embodiments of the present disclosure.

### DETAILED DESCRIPTION

The present disclosure relates to networked sensor devices that are configured to report readings from temperature sensors, motion sensors, humidity sensors, vibration sensors, accelerometers, water sensors, and/or other sensors. The networked sensor devices may be highly portable and may communicate over a wired network or a wireless network such as Wi-Fi or a cellular network. The networked sensor devices may communicate by way of email messages to facilitate reporting and configuration. In this way, the networked sensor devices may avoid having unnecessary internal memory as sensor logs may be maintained by the networked sensor devices on an email server within multiple email messages. In other words, the networked sensor device may be configured not to persist sensor readings within the device once the sensor readings are emailed.

The networked sensor devices may be powered by a battery, by plugging into a wall power receptacle to receive mains power, or by stray radio-frequency (RF) signals. The stray RF signals may be captured by antenna, rectified, and stored. In one embodiment, the stray RF signals may be stored in a low-leakage lithium polymer battery. This stray charge may be used to send emails on a fairly infrequent basis, such as weekly or less frequent.

A client application may access the email messages and generate statistics and reports. The client application may also configure the networked sensor devices by way of sending one or more email messages to an email account accessed by the networked sensor devices. In the following discussion, a general description of the system and its components is provided, followed by a discussion of the operation of the same.

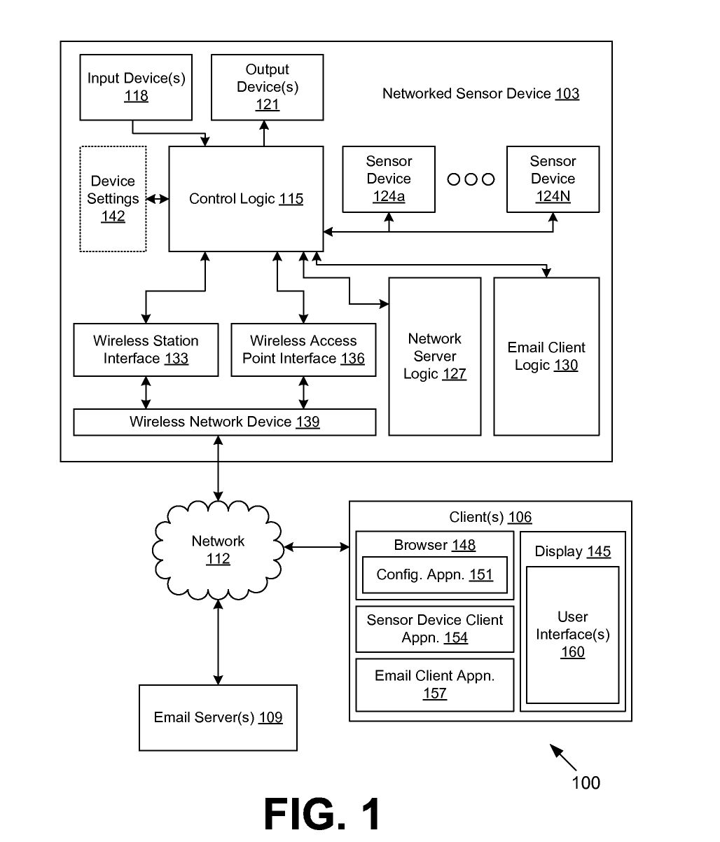

With reference to FIG. 1, shown is a networked environment 100 according to various embodiments. The networked environment 100 includes one or more networked sensor devices 103, one or more clients 106, and one or more email servers 109 in data communication by way of a network 112. The network 112 includes, for example, the Internet, intranets, extranets, wide area networks (WANs), local area networks (LANs), wired networks, wireless networks, or other suitable networks, etc., or any combination of two or more such networks.

The networked sensor device 103 may include control logic 115, one or more input devices 118, one or more output devices 121, one or more sensor devices 124a . . . 124N, network server logic 127, email client logic 130, a wireless station interface 133, a wireless access point interface 136, a wireless network device 139, and/or other applications, services, processes, systems, engines, devices, or functionality not discussed in detail herein. In other embodiments, the networked sensor device may include an Ethernet, power line communications, or other wired network device interface in place of or in addition to the wireless station interface 133, the wireless access point interface 136, and the wireless network device 139. The networked sensor device 103 may store data such as device settings 142 and/or other data. In one embodiment, the device settings 142 are stored in flash memory.

The control logic 115 is executed to perform the various functions of monitoring readings from the sensor devices 124, processing the readings, and making reports by way of email. The control logic 115 also obtains configuration settings by way of email and stores configuration settings in the device settings 142. Further, the control logic 115 may obtain other control-related emails that are processed to activate switches, relays, or other devices. Such devices may include lighting, appliances, door locks, cameras, and/or other devices. For example, the control logic 115 may receive an email directing the networked sensor device 103 to turn on a particular light bulb.

The one or more input devices 118 may include buttons and/or other input devices that may trigger various functions; e.g., placing the networked sensor device 103 in a configuration mode, performing reset functions, performing pairing functions, and so on. The one or more output devices 121 may include light emitting diodes (LEDs), liquid crystal displays (LCDs), incandescent lamps, and/or other output devices that may indicate status and/or sensor readings from the networked sensor device 103.

The sensor devices 124 may include various sensors such as a temperature sensor, a motion sensor, a humidity sensor, a vibration sensor, an accelerometer, a water sensor, a battery status sensor, and/or other sensors. The sensor devices 124 may be coupled to the control logic 115 by way of an inter-integrated circuit (I²C) bus, a 1-wire bus, or another type of local interface. In one embodiment, I²C and 1-wire sensor devices 124 may be supported on the same bus at the same time. One or more of the sensor devices 124 may be built-in to the networked sensor device 103, while one or more other sensor devices 124 may be coupled to the networked sensor device 103 by way of one or more external ports. The sensor devices 124 may generate digital and/or analog readings for consumption by the control logic 115.

The network server logic 127 may correspond to logic that implements a network server (e.g., a hypertext transfer protocol (HTTP) server or other server) for the purpose of facilitating initial configuration. In one embodiment, the network server logic 127 sends a client-executable program to the networked sensor device 103. The client-executable program facilitates specification of configuration settings by way of a client 106 and upload of a configuration settings image from the client 106. The email client logic 130 may correspond to logic that facilitates sending and receiving emails. To this end, the email client logic 130 may support Simple Mail Transfer Protocol (SMTP) and/or other protocols for sending email messages, Internet Message Access Protocol (IMAP) for receiving email messages, Post Office Protocol (POP) for receiving email messages, and/or other protocols for receiving email messages.

The wireless network device 139 may enable communication over Wi-Fi networks (e.g., 802.11, ZigBee, Bluetooth, etc.), cellular networks (e.g., Global System for Mobile Communications (GSM), Wideband Code Division Multiple Access (WCDMA), etc.), and/or other wireless networks. Although the networked sensor device 103 is described herein as a wireless device, in some embodiments, power line communications, Ethernet, and/or other wired network technologies may be used in place of wireless network technologies. The wireless access point interface 136 enables the networked sensor device 103 to act as a wireless access point. In this way, the client 106 is able to connect to the networked sensor device 103 for configuration purposes without prior network configuration of the networked sensor device 103. After configuration, the networked sensor device 103 connects to the network 112 automatically by way of the wireless station interface 133.

The client 106 is representative of a plurality of client devices that may be coupled to the network 112. The client 106 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client 106 may include a display 145. The display 145 may comprise, for example, one or more devices such as cathode ray tubes (CRTs), liquid crystal display (LCD) screens, gas plasma-based flat panel displays, LCD projectors, or other types of display devices, etc.

The client 106 may be configured to execute various applications such as a browser 148, a configuration application 151, a sensor device client application 154, and an email client application 157. The client 106 may be configured to execute other applications such as, for example, mobile applications, instant message applications, and/or other applications.

The browser 148 may be executed in a client 106, for example, to access and render network pages, such as web pages, or other network content served up by the networked sensor device 103 and/or other servers, thereby generating a rendered network page on the display 145. In one embodiment, the browser 148 obtains and executes the configuration application 151 from the network server logic 127.

The configuration application 151 facilitates configuration of the various device settings 142 by way of a web-based interface. In one example, the configuration application 151 corresponds to JavaScript or other browser-executable code and is executed offline by the browser 148. The configuration application 151 renders a user interface 160 on the display 145 to facilitate user specification of settings for the networked sensor device 103. The configuration application 151 may generate a flash image of the device settings 142 which may be uploaded on completion to the network server logic 127.

The sensor device client application 154 may be configured to report sensor readings and results from the networked sensor device 103 to the user by way of a user interface 160. In one embodiment, the sensor device client application 154 is a standalone application. In another embodiment, the sensor device client application 154 is executed by the browser 148 similarly to the configuration application 151. The sensor device client application 154 may be configured to obtain sensor readings and results from one or more email servers 109.

In one embodiment, the sensor device client application 154 may use IMAP to obtain multiple email messages through a single request. The sensor readings may be stored using IMAP “internal date” and “sent” date fields to indicate a timespan. IMAP search features may be leveraged, employing the internal data fields in order to obtain a range of messages corresponding to sensor readings and results corresponding to any particular time period.

The sensor device client application 154 may also facilitate configuration of the networked sensor device 103 by way of a user interface 160. To this end, the sensor device client application 154 may generate emails containing device settings 142 which may be directed to an email address monitored by the networked sensor device 103. The sensor device client application 154 may provide the data in graphical and/or numeric form. The sensor device client application 154 may also provide export functionality for the data, e.g., to comma separated value (CSV) files or other file formats.

The email client application 157 may be configured to check email accounts hosted by the email servers 109 as well as to send email messages to accounts monitored by the networked sensor devices 103. The email client application 157 may receive alert email messages generated by the networked sensor device 103 and display those messages to the user by way of a user interface 160. The email client application 157 may support SMTP, IMAP, POP, and/or other email protocols. In one embodiment, the functionality of the email client application 157 may be provided through a web-based application and the browser 148.

The email server(s) 109 correspond to one or more computing devices which perform email server functions using SMTP, IMAP, POP, and/or other protocols. The email server(s) 109 may, for example, be operated by Internet service providers (ISPs) and/or other third-party entities.

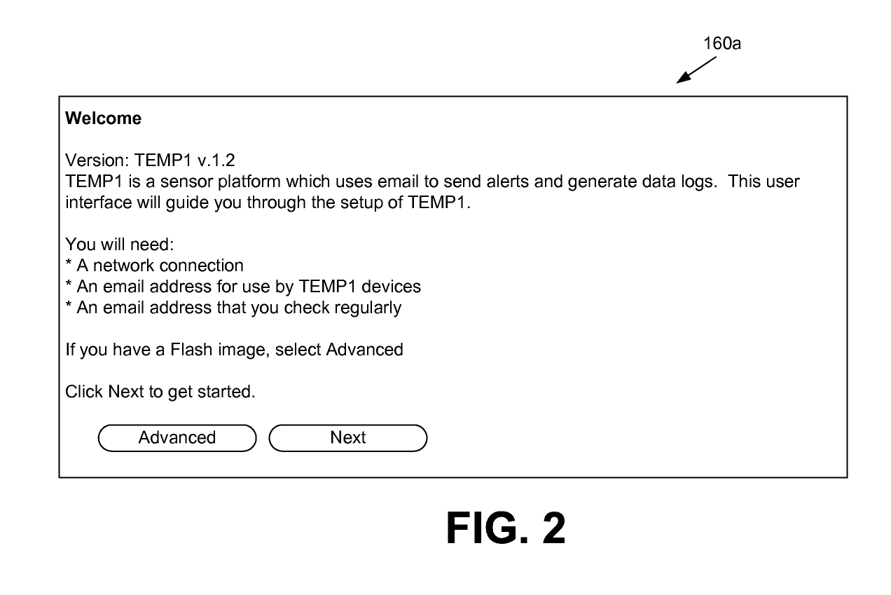

Referring next to FIGS. 2-13, shown are examples of user interfaces 160 rendered by the browser 148 executing the configuration application 151 to configure a networked sensor device 103. FIG. 2 shows a user interface 160a that corresponds to a welcome screen generated by the configuration application 151. In one example, to arrive at this screen, the user puts the batteries (e.g., two AAA batteries) into the networked sensor device 103, and waits for an LED to turn green or another color to indicate that the networked sensor device 103 is ready.

Then, the user connects the client 106 to the networked sensor device 103 via the network 112 and the wireless access point interface 136. The wireless access point interface 136 may be configured to use a default service set identifier (SSID) such as “TEMP1 Setup.” The user then opens a browser 148 and connects to a predefined uniform resource locator (URL) corresponding to the network server logic 127. The network server logic 127 then serves up code corresponding to the configuration application 151 to the browser 148, which then renders the welcome screen shown in FIG. 2.

It is noted that the networked sensor device 103 may enter a low power state after sending the configuration application 151. Because the client 106 has all the data that is used to perform the setup, the networked sensor device 103 may enter a sleep mode until the user is ready to program the networked sensor device 103. Images and network page components are created client-side by JavaScript in the configuration application 151. For example, all images may be drawn dynamically, pixel by pixel, using one pixel square DIV tags. These images may be stored as text in the configuration application 151 and compressed.

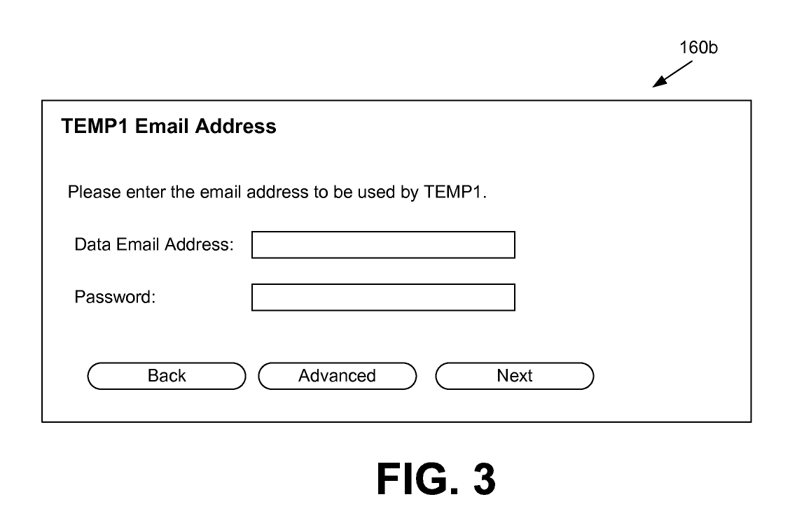

FIG. 3 shows a user interface 160b which allows entry of an email account on the email server 109 for use by the networked sensor device 103 for purposes of storing log data and receiving configuration emails. The user may supply an email address and a password. It is noted that multiple networked sensor devices 103 may utilize the same email account in order to store log data and receive configuration emails. Each of the multiple networked sensor devices 103 may be assigned a unique identifier (e.g., using a portion of a media access control (MAC) address), and the unique identifier may be employed to distinguish data emails and folders in the single account among the multiple networked sensor devices 103. The networked sensor device 103 may create multiple folders within the email account on the email server in order to distinguish different types of email messages.

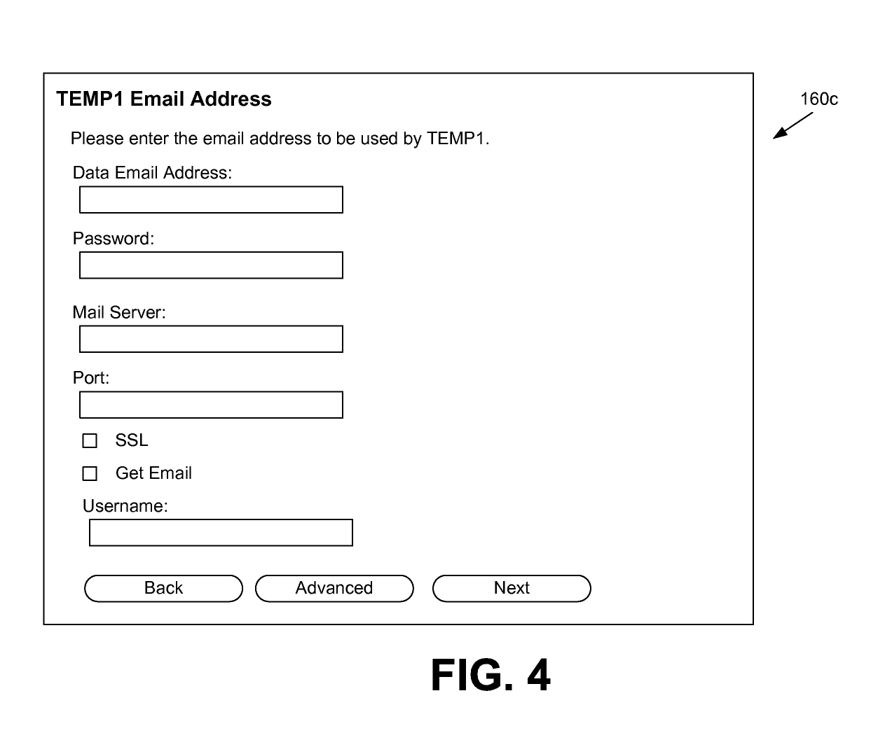

FIG. 4 shows a user interface 160c that corresponds to an advanced version of the user interface 160b of FIG. 3. In this user interface 160c, the user may specify an incoming email account (e.g., IMAP, POP, etc.). In one embodiment, the user may also specify an outgoing email account (e.g., SMTP, etc.). In another embodiment, an outgoing email account is unnecessary when an email message can be created directly upon an IMAP or other mail server using IMAP append or another approach. The user may specify internet protocol (IP) addresses, domain names, port numbers, and/or other information. The user may specify whether secure sockets layer (SSL) or another form of secure communication is to be used.

The user may also specify whether the networked sensor device 103 is to obtain configuration emails from the incoming email account (“Get Email” feature). Such configuration emails may change input/output settings, thresholds, periods for logging, and/or other settings. Such emails may also comprise control emails directing the networked sensor device 103 to activate or deactivate various switches, relays, and/or other devices. The user may also specify a username for the accounts. The username may be different from the email address itself.

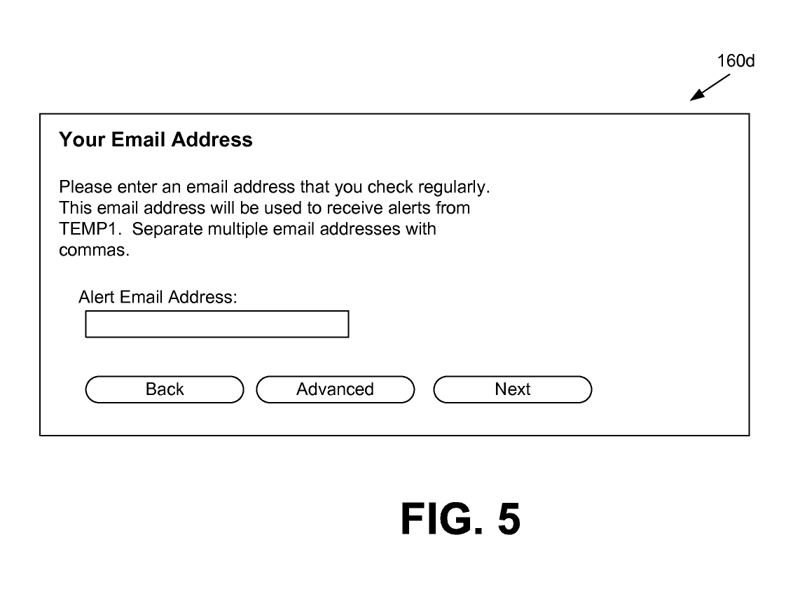

FIG. 5 shows a user interface 160d that allows the specification of an alert email address to which the networked sensor device 103 may send alert email messages. The networked sensor device 103 may be configured merely to send emails to this address and not to check this address. This should be an email address that the user checks often. Multiple email addresses may be specified. In other embodiments, the user may specify telephone numbers that the networked sensor device 103 is to call or to leave a text message. In one embodiment, the networked sensor device 103 may be configured to send an alert email that includes or links to a graph of data, e.g., a hypertext markup language (HTML) graph, bitmapped graph, or other graph. Thus, the alert message may include historical readings in the graph to indicate what happened before the alert was generated.

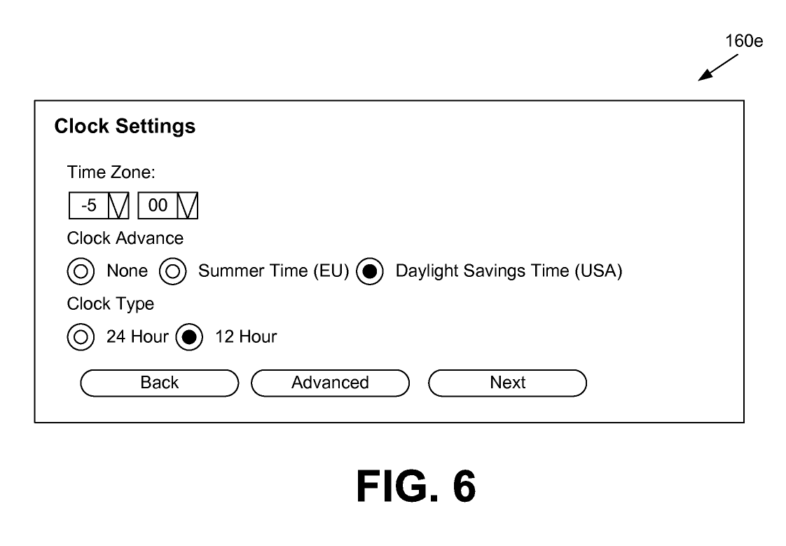

FIG. 6 shows a user interface 160e that facilitates the specification of various clock settings. The user is able to configure the time zone, a clock advance (e.g., daylight savings time, summer time, etc.), a clock type (e.g., 24 hour, 12 hour), and/or other time-related settings.

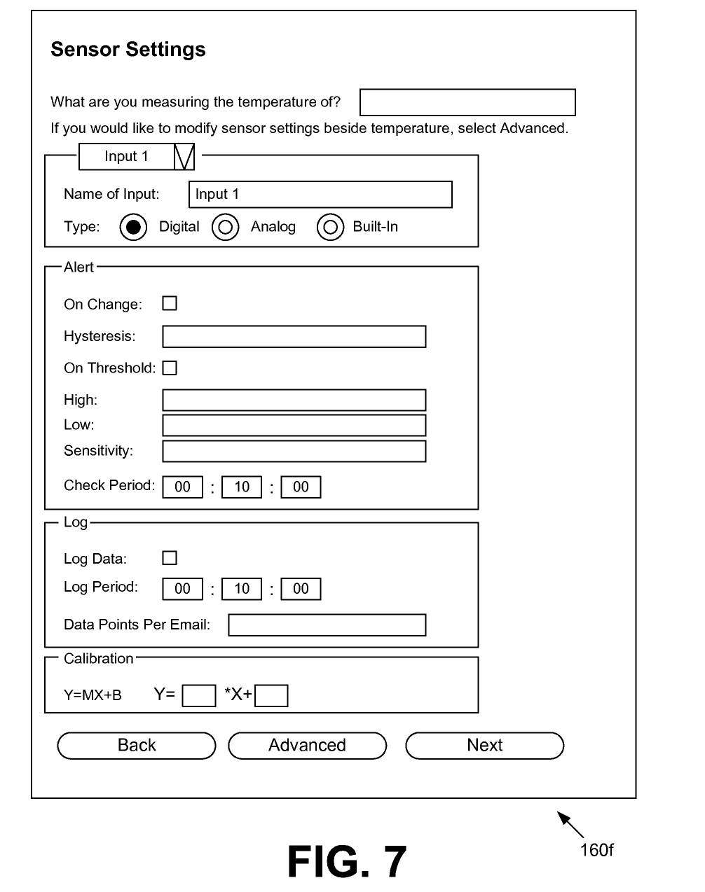

FIG. 7 shows a user interface 160f that facilitates the specification of various sensor settings. The user is able to specify a textual description for the sensor (e.g., where the sensor is located). The user is also able to provide a name for various sensor device 124 inputs, and to specify whether the input is digital, analog, or “built-in.” In one example, “built-in” selects I²C mode. If an I²C device is plugged into the networked sensor device 103, the “built-in” option becomes selectable. In one embodiment, the networked sensor device 103 supports two analog or digital inputs. Various battery settings may also be configured through this user interface 160f.

Alert settings may be specified. As an example, an alert may be generated when the value measured by the sensor device 124 changes. To this end, a hysteresis setting may be specified. As another example, an alert may be generated when the value measured by the sensor meets a threshold. A value for a high threshold, a value for a low threshold, a sensitivity value, and/or other threshold-related values may be specified. A check period may be specified to determine how often the networked sensor device 103 is to check the sensor device 124 values for an alert.

Log settings may be specified. If logging is enabled, sensor values may be recorded according to a specified log period. Because the networked sensor device 103 may use email for logging, a setting may control the number of data points to be logged per email message. For example, a sensor value may be logged every 30 seconds, and two data points may be specified per email. Accordingly, an email message with two data points may be logged every minute.

Calibration settings may be specified. For example, a scaling factor M and a constant factor B may be used to adjust the raw values obtained from the sensor device 124 before evaluation of alerts and/or logging. Each sensor device 124 may have its own section for calibration.

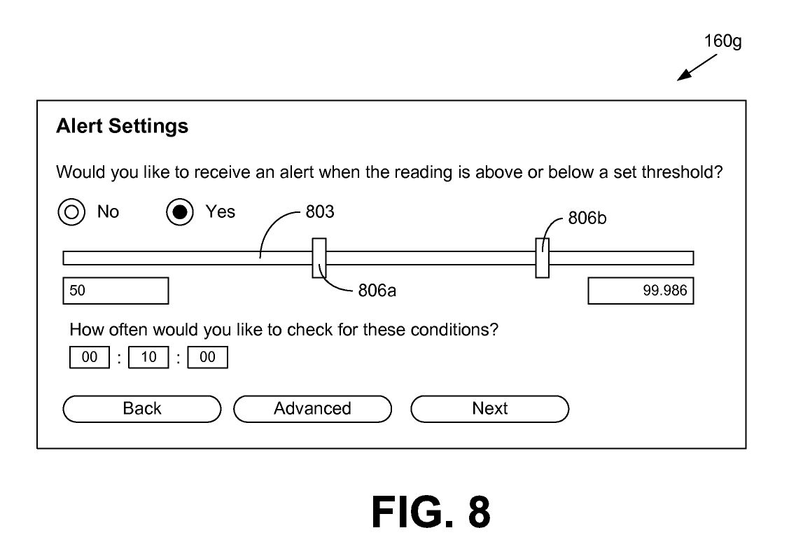

FIG. 8 shows a user interface 160g that provides a simplified way to configure alert settings. The user is able to specify whether an alert is to be generated when the sensor value is above or below a set threshold. A graphical slider 803 enables the selection of the threshold range. The pegs 806a and 806b of the graphical slider 803 define the threshold range. Readouts of precise values corresponding to the pegs 806 may be provided. The user may also specify a period for checking for these threshold conditions.

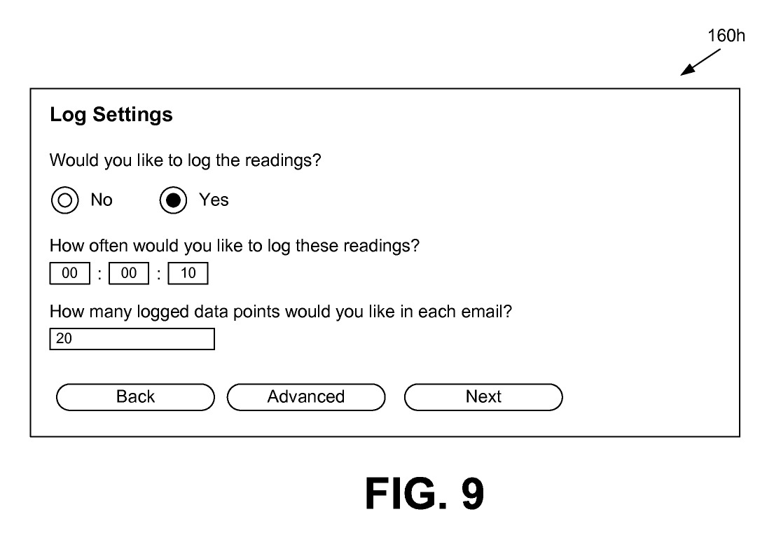

FIG. 9 shows a user interface 160h that provides an approach to configure log settings. The user is able to specify whether a sensor value (e.g., a temperature value) is to be logged. The user is able to specify a period for logging the sensor value, and a number of data values to be included in each logging email message. The logging data is sent to the data email address used by the networked sensor device 103.

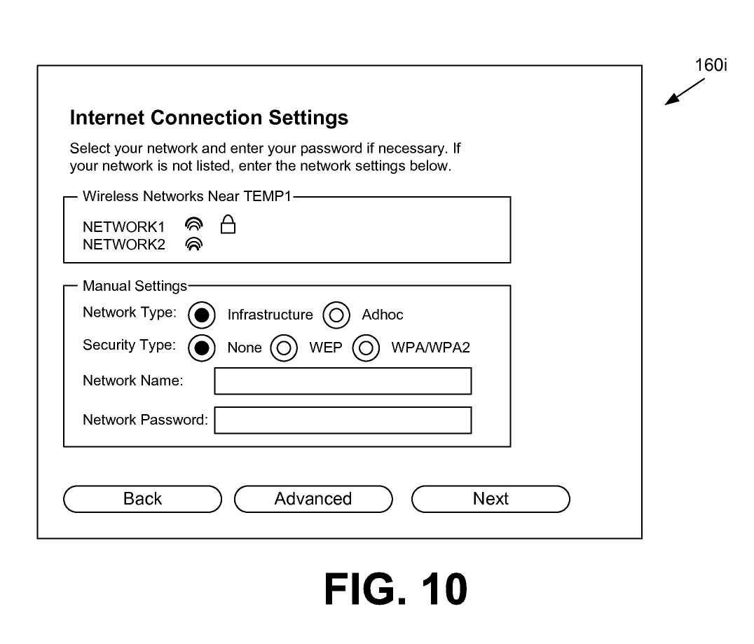

FIG. 10 shows a user interface 160i that facilitates configuration of the wireless station interface 133 of the networked sensor device 103. A listing of automatically detected wireless networks is shown, and the user is able to specify various types of wireless network settings manually. The user is able to specify a SSID, network password, and/or other credentials in order to connect to a selected wireless network.

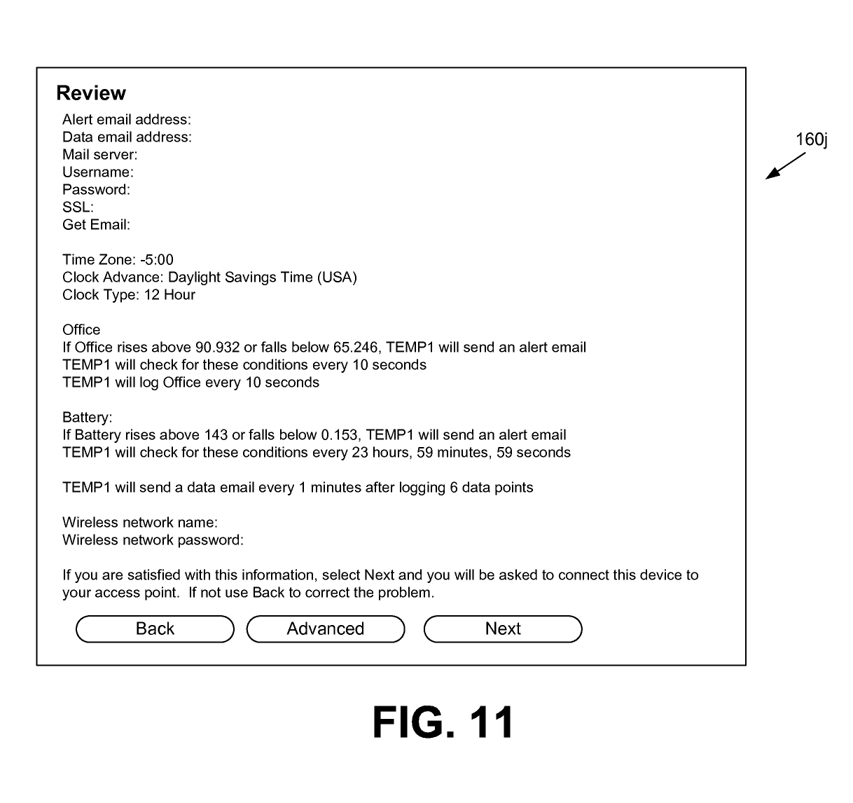

FIG. 11 shows a user interface 160j that provides a review of the various settings that have been configured by way of the previous user interface 160 screens. The user interface 160j summarizes the email address settings, the clock settings, the sensor settings, the battery settings, the logging settings, the wireless network settings, and/or other configuration settings.

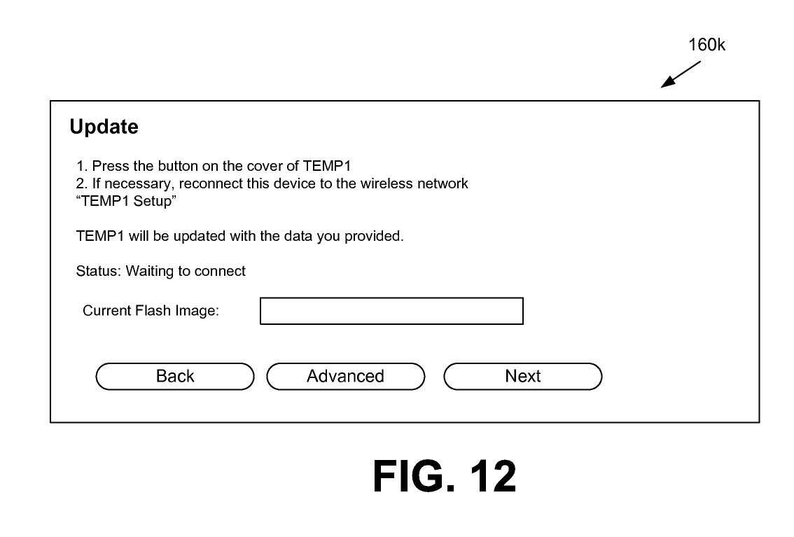

FIG. 12 shows a user interface 160k that facilitates updating the device settings 142 of the networked sensor device 103 with the settings that have been configured by way of the previous user interface 160 screens. A flash image including the settings may be generated by the configuration application 151. The user is instructed to select a button input device 118 on the networked sensor device in order to wake up the networked sensor device 103 to update the device settings 142.

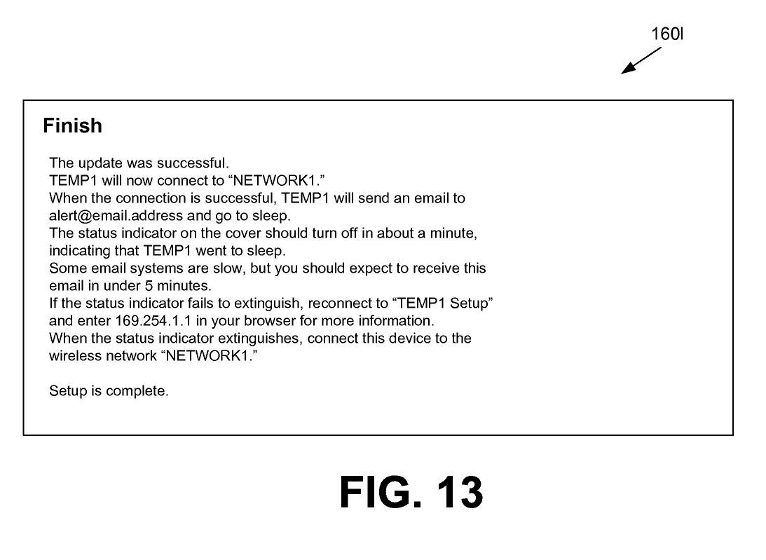

FIG. 13 shows a user interface 160l that provides the results of the update procedure. The user interface 160l indicates that the networked sensor device 103 will go to sleep to conserve power between monitoring periods. The networked sensor device 103 may send alert emails and store logging emails as configured.

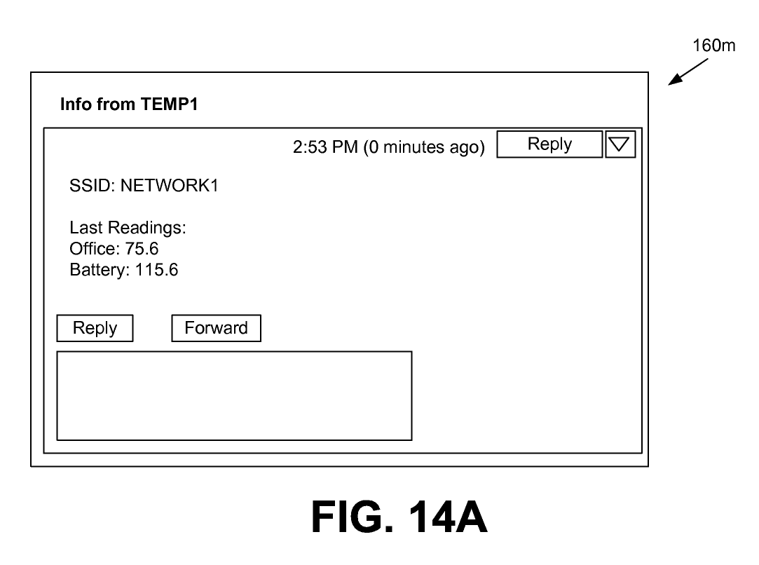

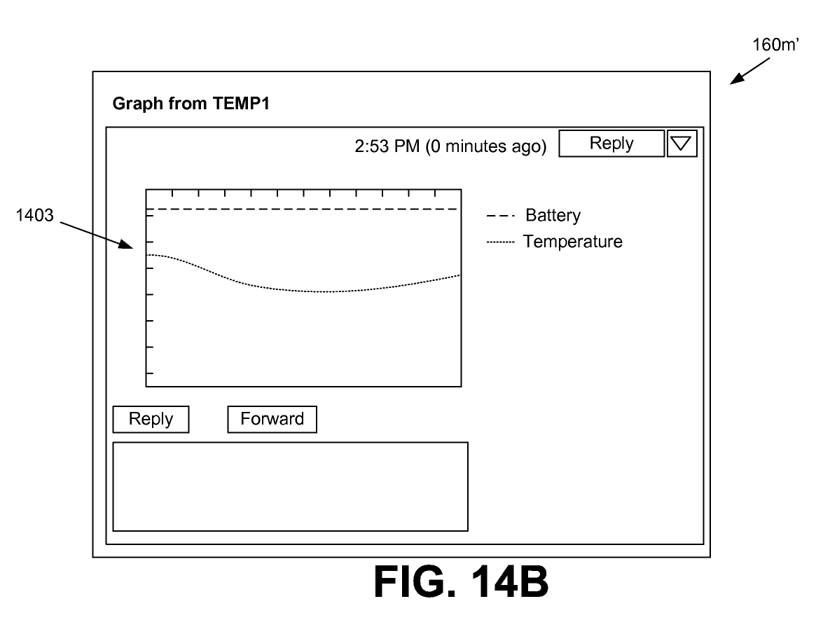

Turning now to FIG. 14A, shown is one example of a user interface 160m rendered by the email client application 157 executed in the client 106 in the networked environment 100. FIG. 14A depicts an email message that has been received by the email server 109 from the networked sensor device 103. This exemplary email message contains the latest readings from two sensor devices 124. This information message may be generated in response to the user pressing a button or activating another input device 118 of the networked sensor device 103. In other examples, the email message may also indicate whether an alert has been generated and detailed information about the alert.

FIG. 14B illustrates another example of a user interface 160m′ rendered by the email client application 157 executed in the client 106 in the networked environment 100. FIG. 14B depicts an email message that has been received by the email server 109 from the networked sensor device 103. This exemplary email message contains a graph 1403 generated by the networked sensor device 103 and showing readings from two input devices, a battery sensor and temperature sensor.

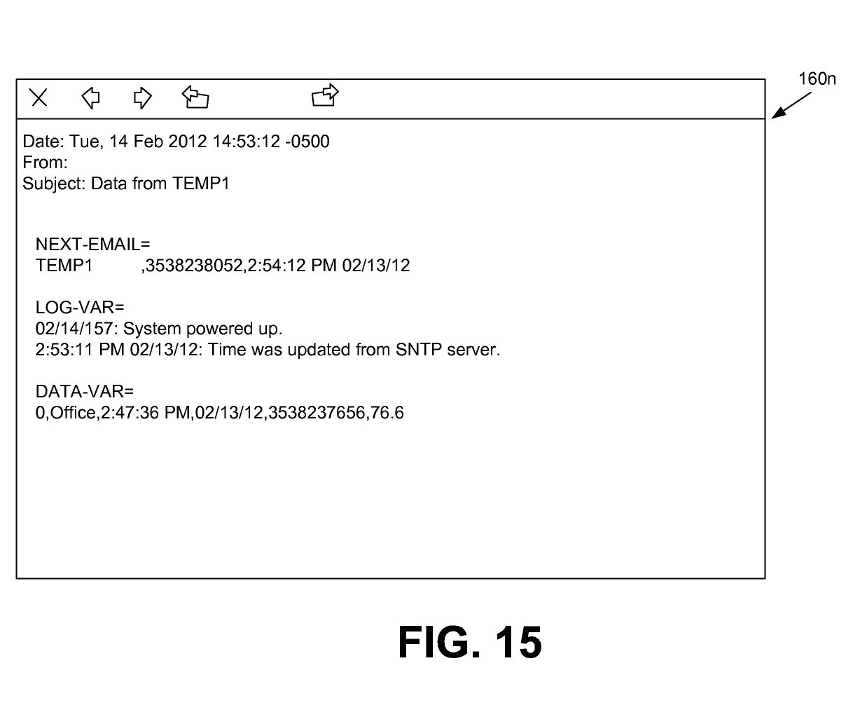

FIG. 15 shows another example of a user interface 160n rendered by the email client application 157 executed in the client 106 in the networked environment 100. FIG. 15 depicts an email message that has been received by the email server 109 from the networked sensor device 103. This exemplary email message contains information about when the next email will be sent, logged system events, and logged sensor data. The logged sensor data may include, for example, a sensor identifier, a sensor name, local time, local date, timestamp, a current sensor value, and/or other data.

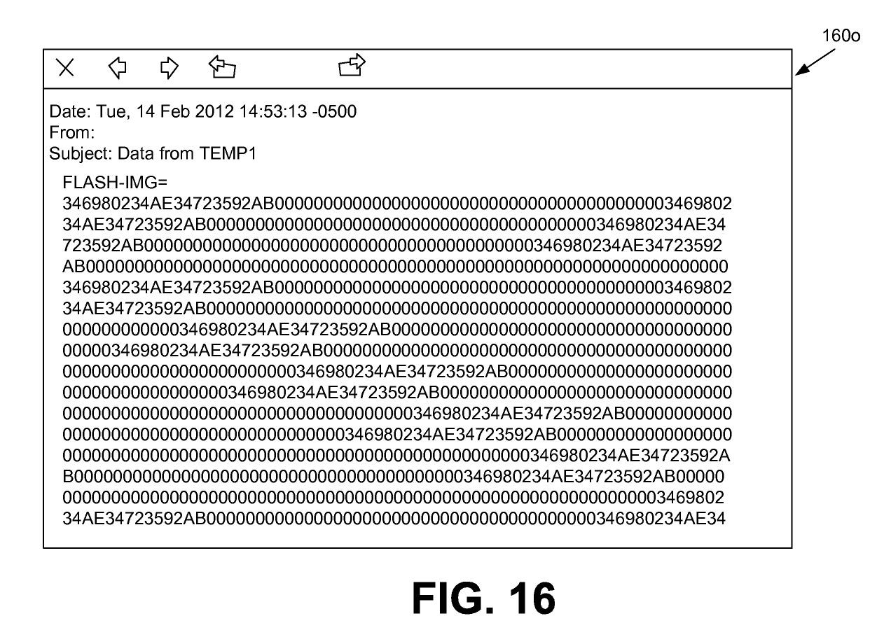

FIG. 16 shows another example of a user interface 160o rendered by the email client application 157 executed in the client 106 in the networked environment 100. FIG. 16 depicts an email message encoding a flash image used to configure the device settings 142 of the networked sensor device 103. In this example, the flash image is encoded in a hexadecimal format, although other encodings may be used. The networked sensor device 103 may be configured to download the flash image in the email message automatically and apply the changes to the device settings 142.

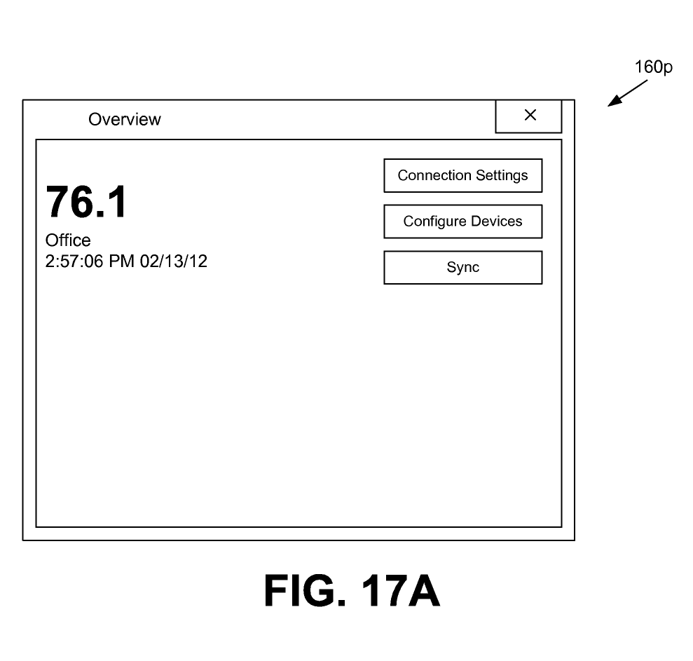

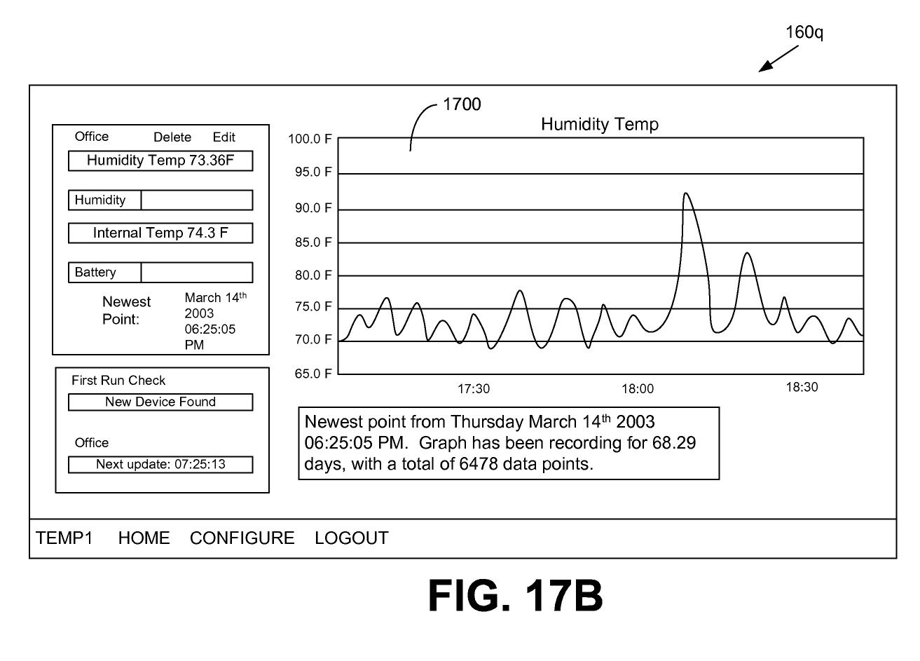

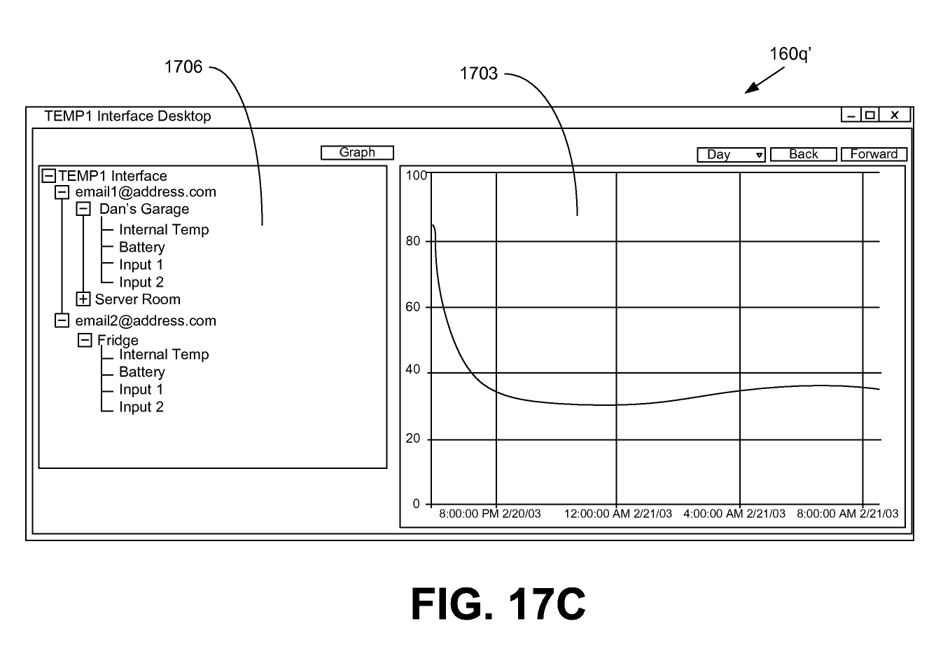

Moving on to FIGS. 17A-20, shown are examples of user interfaces 160 generated by the sensor device client application 154 executed in the client 106 in the networked environment 100. FIG. 17A shows a user interface 160p that corresponds to an overview screen of the sensor device client application 154. The overview screen shows a current sensor reading, a sensor name, and a time associated with the sensor reading. The user interface 160 also includes user interface components to specify connection settings, configure devices, and to synchronize settings with the networked sensor device 103. It is noted that the sensor device client application 154 may be configured to control multiple networked sensor devices 103 in the networked environment 100.

FIG. 17B shows an alternative browser-based user interface 160q corresponding to the sensor device client application 154 executed in the client 106 in the networked environment 100. The user interface 160q may include a graph 1700 of a predefined or selected range of data points obtained from the email account. The user may select a time range on the graph 1700 and the graph may be zoomed in to the selected time range. Alternatively, the user may zoom out (e.g., by right clicking or selecting a zoom out component) to include a longer time range. The user interface 160q may indicate the latest sensor reading, how long sensor readings have been taken, when the next sensor reading is scheduled, and other information. In some cases, to access the user interface 160q, a user may access an external network site and provide credentials to access the email account where the networked sensor device 103 stores data.

FIG. 17C shows an user interface 160q′ corresponding to the sensor device client application 154 executed in the client 106 in the networked environment 100. The user interface 160q′ may include a graph 1703 of a predefined or selected range of data points obtained from an email account. Additionally, the user interface 160q′ may include a selection interface 1706 that allows selection from multiple networked sensor devices 103 potentially from multiple email accounts. The selection interface 1706 in this example is a tree-based hierarchical interface, but other interfaces could be employed in other embodiments.

The selection interface 1706 indicates the use of two email accounts: “email1@address.com” and “email2@address.com.” The account “email1@address.com” is associated with two networked sensor devices 103: “Dan's Garage” and “Server Room.” The account “email2@address.com” is associated with one networked sensor device 103: “Fridge.” Each of these networked sensor devices 103 may have one or multiple sensors that are selectable through the selection interface 1706, for example, “Internal Temp,” “Battery,” “Input 1,” and “Input 2.” When a particular sensor is selected, the graph 1703 or other portions of the user interface 160q′ may be updated to reflect data for the selected sensor.

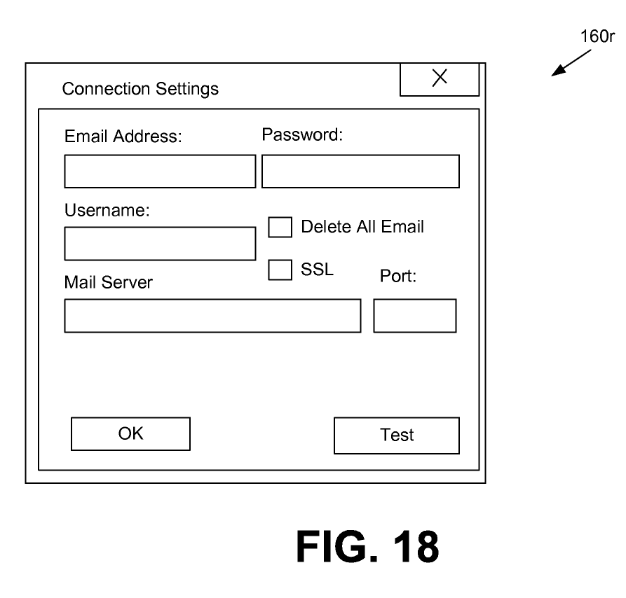

FIG. 18 shows a user interface 160r that facilitates configuration of various email settings for the sensor device client application 154. In particular, a user may specify an email address, username, password, an incoming mail server, an outgoing mail server, whether a secure connection is to be used, whether emails are to be deleted, and/or other parameters. The sensor device client application 154 connects to the specified email servers 109 to obtain sensor data emails generated by the networked sensor device 103 and to send configuration emails to the networked sensor device 103.

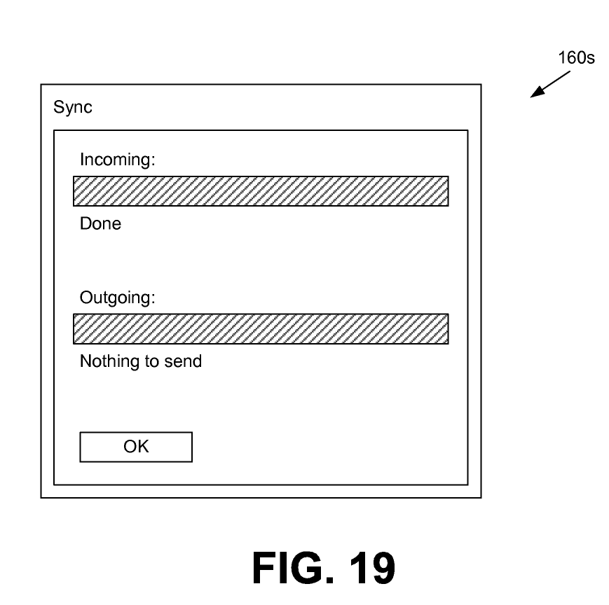

FIG. 19 shows a user interface 160s that indicate a current state of a synchronization operation that synchronizes the device settings 142 as known by or configured in the sensor device client application 154 with the state of the networked sensor device 103. An email message with the new settings may be sent to networked sensor device 103, which may then consume the email message from the email server 109 and apply the new device settings 142. In one embodiment, the email message includes a flash image as previously discussed.

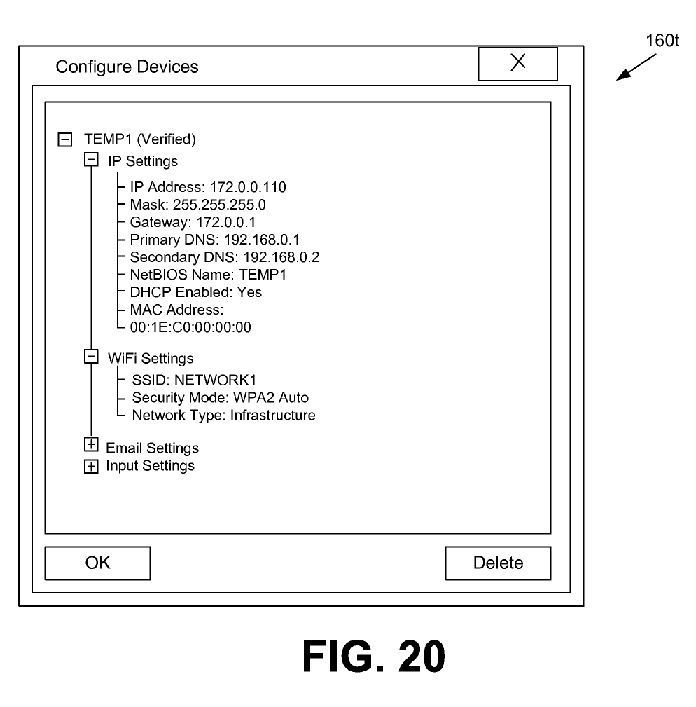

FIG. 20 shows a user interface 160t that facilitates viewing and configuration of the various device settings 142 used by the networked sensor device 103. The user interface 160 shows a tree-based settings hierarchy. In one embodiment, some or all of the settings may be selected and updated by the user through the user interface 160.

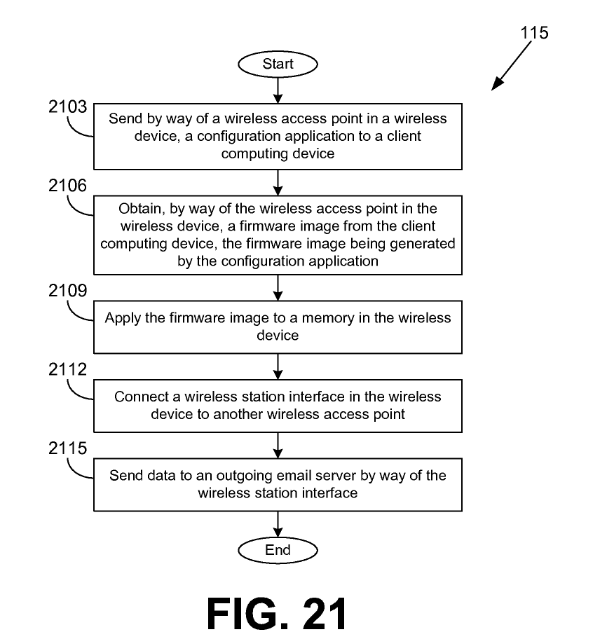

Referring next to FIG. 21, shown is a flowchart that provides one example of the operation of a portion of the control logic 115 according to various embodiments. It is understood that the flowchart of FIG. 21 provides merely an example of the many different types of functional arrangements that may be employed to implement the operation of the portion of the control logic 115 as described herein. As an alternative, the flowchart of FIG. 21 may be viewed as depicting an example of steps of a method implemented in the networked sensor device 103 (FIG. 1) according to one or more embodiments.

Beginning with box 2103, the control logic 115 sends code that implements a configuration application 151 to a client 106. The code is sent by way of a wireless access point interface 136 in the networked sensor device 103. In one embodiment, the code is sent by the network server logic 127. In box 2106, the control logic 115 obtains a firmware image from the client 106. The firmware image is generated by the configuration application 151, and is obtained by the control logic 115 by way of the wireless access point interface 136.

In box 2112, the control logic 115 applies the firmware image to a memory in the networked sensor device 103. In box 2112, the control logic 115 connects the wireless station interface 133 in the networked sensor device 103 to another wireless access point using the device settings 142 configured by the firmware image. In box 2115, the control logic 115 sends data to an outgoing email server 109 by way of the wireless station interface 133 and the network 112. The data may include logging data, reporting data, alert data, and so on. In one embodiment, the control logic 115 may store the data directly on an IMAP server without sending the data through an SMTP server. The control logic 115 may manipulate various IMAP message data fields to indicate a timespan for the data included in the message. For example, the sent field and the internal data field of the IMAP message may indicate a start time and an end time for the timespan encompassed by the message. Thereafter, the portion of the control logic 115 ends.

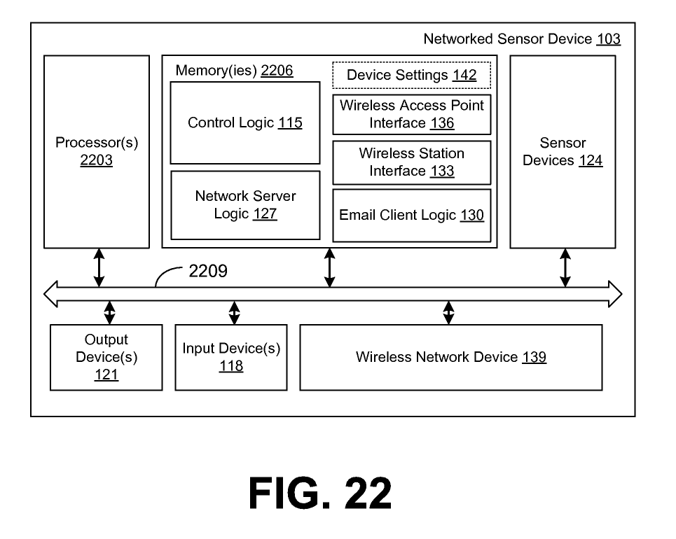

With reference to FIG. 22, shown is a schematic block diagram of the networked sensor device 103 according to an embodiment of the present disclosure. The networked sensor device 103 includes at least one processor circuit, for example, having a processor 2203 and a memory 2206, both of which are coupled to a local interface 2209. The local interface 2209 may also be coupled to the sensor devices 124, the wireless network device 139, the input device(s) 118, the output device(s) 121, and/or other hardware systems. The local interface 2209 may comprise, for example, a data bus with an accompanying address/control bus or other bus structure as can be appreciated.

Stored in the memory 2206 are both data and several components that are executable by the processor 2203. In particular, stored in the memory 2206 and executable by the processor 2203 are the control logic 115, the network server logic 127, the wireless access point interface 136, the wireless station interface 133, the email client logic 130, and potentially other systems. Also stored in the memory 2206 may be the device settings 142 and other data. In addition, an operating system may be stored in the memory 2206 and executable by the processor 2203.

It is understood that there may be other applications that are stored in the memory 2206 and are executable by the processor 2203 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Delphi®, Flash®, or other programming languages.

A number of software components are stored in the memory 2206 and are executable by the processor 2203. In this respect, the term “executable” means a program file that is in a form that can ultimately be run by the processor 2203. Examples of executable programs may be, for example, a compiled program that can be translated into machine code in a format that can be loaded into a random access portion of the memory 2206 and run by the processor 2203, source code that may be expressed in proper format such as object code that is capable of being loaded into a random access portion of the memory 2206 and executed by the processor 2203, or source code that may be interpreted by another executable program to generate instructions in a random access portion of the memory 2206 to be executed by the processor 2203, etc. An executable program may be stored in any portion or component of the memory 2206 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 2206 is defined herein as including both volatile and nonvolatile memory and data storage components. Volatile components are those that do not retain data values upon loss of power. Nonvolatile components are those that retain data upon a loss of power. Thus, the memory 2206 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 2203 may represent multiple processors 2203 and the memory 2206 may represent multiple memories 2206 that operate in parallel processing circuits, respectively. In such a case, the local interface 2209 may be an appropriate network that facilitates communication between any two of the multiple processors 2203, between any processor 2203 and any of the memories 2206, or between any two of the memories 2206, etc. The local interface 2209 may comprise additional systems designed to coordinate this communication, including, for example, performing load balancing. The processor 2203 may be of electrical or of some other available construction.

Although the control logic 115, the network server logic 127, the wireless access point interface 136, the wireless station interface 133, the email client logic 130, the configuration application 151, the sensor device client application 154, the email client application 157, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowchart of FIG. 21 shows the functionality and operation of an implementation of portions of the control logic 115. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 2203 in a computer system or other system. The machine code may be converted from the source code, etc. If embodied in hardware, each block may represent a circuit or a number of interconnected circuits to implement the specified logical function(s).

Although the flowchart of FIG. 21 shows a specific order of execution, it is understood that the order of execution may differ from that which is depicted. For example, the order of execution of two or more blocks may be scrambled relative to the order shown. Also, two or more blocks shown in succession in FIG. 21 may be executed concurrently or with partial concurrence. Further, in some embodiments, one or more of the blocks shown in FIG. 21 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the control logic 115, the network server logic 127, the wireless access point interface 136, the wireless station interface 133, the email client logic 130, the configuration application 151, the sensor device client application 154, and the email client application 157, that comprises software or code can be embodied in any non-transitory computer-readable medium for use by or in connection with an instruction execution system such as, for example, a processor 2203 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

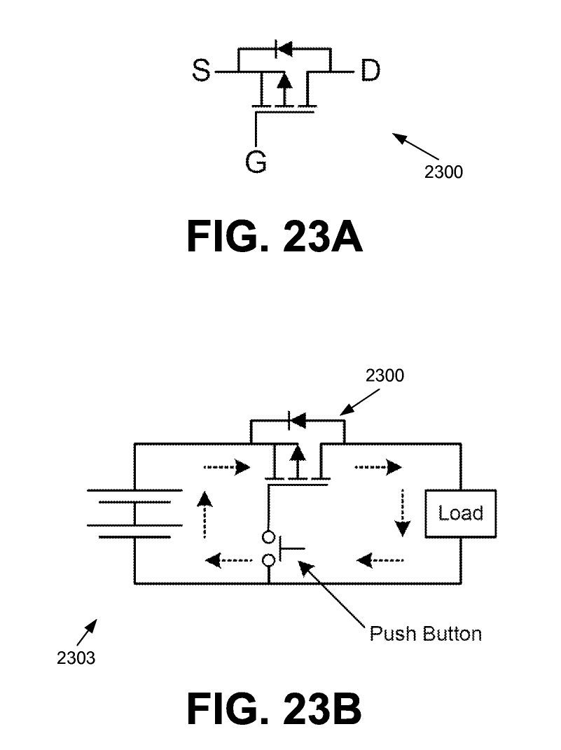

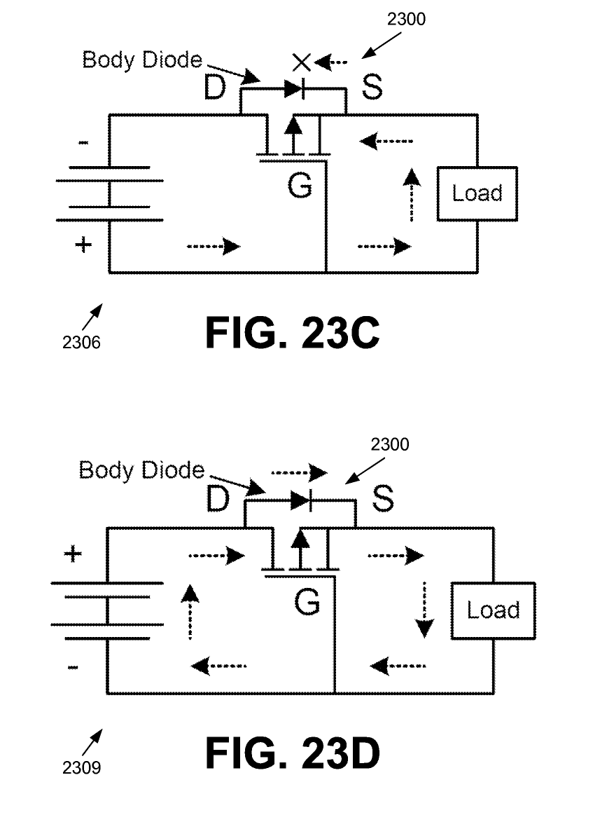

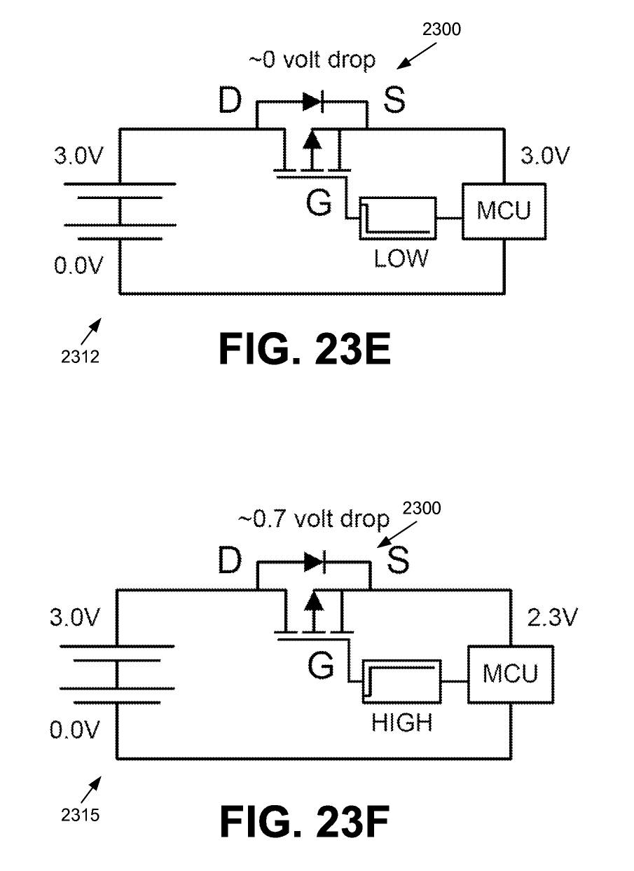

Moving on to FIG. 23A, shown is one example of a P-channel enhancement-mode power metal-oxide-semiconductor field effect transistor (MOSFET) 2300 used in battery protection logic of the networked sensor device 103 in the networked environment 100 (FIG. 1) according to various embodiments of the present disclosure. The MOSFET 2300 includes a source (S), gate (G), and drain (D).

FIG. 23B illustrates one example application 2303 of the P-channel MOSFET 2300 of FIG. 23A according to various embodiments of the present disclosure. In this application 2303, on the introduction of power, no current will flow to the load. When the push button is depressed, the gate of the MOSFET 2300 will be pulled low, creating a potential between source and drain allowing current to flow through MOSFET to the load.

FIG. 23C illustrates one example application 2306 of the P-channel MOSFET 2300 of FIG. 23A as a reverse battery protector according to various embodiments of the present disclosure. In this application 2306, the source and drain of the MOSFET 2300 are swapped. On application of power, current will flow through the body diode to the load. A voltage drop of about 0.7 volts will be realized across the body diode. A potential will be created between the source and gate and the MOSFET 2300 will be switched on, shorting the diode, eliminating the 0.7 volt drop.

FIG. 23D illustrates another example application 2309 of the P-channel MOSFET 2300 of FIG. 23A as a reverse battery protector according to various embodiments of the present disclosure. In this application 2309, the battery polarity is reversed, and the body diode will not allow current to flow. No potential will be realized across the source and the gate of the MOSFET 2300 so the MOSFET 2300 will not be switched on.

FIG. 23E illustrates one example application 2312 of the P-channel MOSFET 2300 of FIG. 23A as a reverse battery protector and battery life extender according to various embodiments of the present disclosure. In this application 2312, the gate of the MOSFET 2300 is connected to a microcontroller (MCU) or a processor which is also the load of the circuit. This circuit offers the same reverse battery protection of the applications 2309, 2306 shown above. When the gate is held low, a 0 volt drop across the MOSFET 2300 is realized.

FIG. 23F illustrates another example application 2315 of the P-channel MOSFET 2300 of FIG. 23A as a reverse battery protector and battery life extender according to various embodiments of the present disclosure. In this application 2315, when the gate of the MOSFET 2300 is held high, the MOSFET 2300 is switched off. Current, however, is still flowing through the body diode. A 0.7 volt drop is realized across the MOSFET 2300. The realized voltage across the microcontroller/processor (MCU) is 2.3 volts.

For battery powered devices, using sleep modes, idle modes, clock speed switching, and other power saving methods are popular for the purpose of extending run time. When many of these modes are activated, the microcontroller/processor does not require full operating voltage. Using a MOSFET 2300 in this approach allows the realized voltage to be decreased across the microcontroller. When the microcontroller/processor does not need full operating voltage, the microcontroller/processor can switch off the MOSFET 2300, relying solely on the body diode contained in the MOSFET 2300 to provide power. This allows the circuit to take advantage of the 0.7 volt drop of the body diode, decreasing gate leakage current inside the microcontroller/processor, further reducing power consumption and therefore increasing run time.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, at least the following is claimed:

1. A networked sensor device, comprising:
at least one processor circuit;
at least one sensor; and
reporting logic, executable by the at least one processor circuit, configured to:
obtain sensor readings from the at least one sensor; and
store the sensor readings in an email server by way of a wireless or wired network.

2. The networked sensor device of claim 1, wherein the reporting logic is configured to send an email message including a graph of at least some of the sensor readings to an email address associated with a user.

3. The networked sensor device of claim 1, wherein the reporting logic is configured to store the sensor readings in a single account of the email server, and another networked sensor device also is configured to store other sensor readings in the single account of the email server.

4. The networked sensor device of claim 1, wherein the reporting logic is configured to:
store a first type of the sensor readings in a first folder of the email server, and
store a second type of the sensor readings in a second folder of the email server.

5. The networked sensor device of claim 1, further comprising control logic, executable by the at least one processor circuit, configured to:
obtain a control email message by way of the network; and
activate or deactivate a device based at least in part on the control email message.

6. The networked sensor device of claim 1, further comprising configuration logic, executable by the at least one processor circuit, configured to:
obtain a configuration email message by way of the network; and
configure the reporting logic based at least in part on the configuration email message.

7. The networked sensor device of claim 6, wherein the configuration email message is obtained from at least one of a Post Office Protocol (POP) server or an Internet Message Access Protocol (IMAP) server.

8. The networked sensor device of claim 6, wherein the configuration email message includes a firmware image, and the configuration logic is further configured to apply the firmware image to a memory of the networked sensor device.

9. The networked sensor device of claim 1, further comprising:
access point logic, executable by the at least one processor circuit, that provides access point services for a Wi-Fi network; and
server logic, executable by the at least one processor circuit, that sends a configuration application to a client computing device by way of the Wi-Fi network, the configuration application facilitating configuration of the networked sensor device.

10. The networked sensor device of claim 9, wherein the configuration application is configured to:
generate a plurality of network pages that facilitate user specification of a plurality of settings for the networked sensor device;
generate a firmware image including the settings to the networked sensor device; and
wherein the server logic is configured to update a memory of the networked sensor device according to the firmware image.

11. The networked sensor device of claim 10, wherein the settings include at least one of a sensor calibration setting, a reporting interval setting, a sensor threshold setting, an email server setting, a time setting, a hysteresis setting, or a wireless network connection setting.

12. The networked sensor device of claim 1, wherein the reporting logic is configured not to persist the sensor readings in the networked sensor device.

13. The networked sensor device of claim 1, wherein the reporting logic is configured to store the sensor readings by creating at least one email message directly on an Internet Message Access Protocol (IMAP) server.

14. The networked sensor device of claim 1, wherein the networked sensor device is powered by a battery, and the at least one sensor includes a sensor configured to monitor a condition of the battery.

15. The networked sensor device of claim 1, wherein the networked sensor device is powered by a battery, the at least one processor circuit is configured to switch off a P-channel enhancement-mode power metal-oxide-semiconductor field effect transistor (MOSFET) configured as a reverse battery protector for the battery when the networked sensor device is in an idle mode, and the networked sensor device is powered through a body diode of the MOSFET when the networked sensor device is in the idle mode.

16. The networked sensor device of claim 1, wherein the networked sensor device is powered by stray radio-frequency signals.

17. A method, comprising the steps of:
sending, by way of a wireless access point in a wireless device, a configuration application to a client computing device;
obtaining, by way of the wireless access point in the wireless device, a firmware image from the client computing device, the firmware image being generated by the configuration application;
applying the firmware image to a memory in the wireless device;
connecting a wireless station interface in the wireless device to another wireless access point; and
sending data to an outgoing email server by way of the wireless station interface.

18. The method of claim 17, further comprising the steps of:
obtaining, in the wireless device, another firmware image in an email message from an incoming email server; and
applying the other firmware image to the memory in the wireless device.

19. The method of claim 17, wherein the data includes a reading from a sensor of the wireless device.

20. The method of claim 17, wherein the wireless device is configured not to persist the data in the wireless device.

21. A system, comprising:
at least one computing device; and
an application executable in the at least one computing device, the application comprising:
logic that obtains at least one reporting email generated by a networked sensor device;
logic that extracts data from the at least one reporting email; and
logic that renders a user interface that presents the data extracted from the at least one reporting email, the data including at least one sensor reading generated by the networked sensor device.

22. The system of claim 21, wherein the logic that obtains the at least one reporting email is configured to obtain a plurality of reporting emails via a plurality of email accounts.

23. The system of claim 21, wherein the application further comprises:
logic that generates another user interface that facilitates user configuration of a plurality of device settings for the networked sensor device;
logic that generates a firmware image based at least in part on at least one of the device settings which has been modified by the user by way of the other user interface; and
logic that sends an email including the firmware image to the networked sensor device, wherein the networked sensor device is configured to download the email and apply the firmware image included in the email.

24. The system of claim 21, wherein the logic that obtains the at least one reporting email is configured to obtain a plurality of reporting emails corresponding to a user-specified range of time via a single request to an email server.

25. The system of claim 21, wherein each respective reporting email is associated with an interval of time covered by a plurality of sensor readings in the respective reporting email, the interval of time being defined by respective data fields maintained by an email server from which the respective reporting email is obtained.
